(19) United States
(12) Patent Application Publication
(10) Pub. No.: US 2009/0021066 A1
(43) Pub. Date: Jan. 22, 2009

(54) SMARTFOLD POWER DRIVE

(75) Inventors: John F. Nathan, Highland Township, MI (US); H. Winston Maue, Farmington Hills, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 12/106,609

(22) Filed: Apr. 21, 2008

Related U.S. Application Data
(60) Provisional application No. 60/950,207, filed on Jul. 17, 2007.

(51) Int. Cl. B60N 2/20

(52) U.S. Cl. 297/362; 297/362.11

(57) ABSTRACT

A smart fold power drive that can be used to electronically articulate a seat with a motor. The drive may be configured to allow partial positioning of the seat while the motor is stopped. The motor may be used to position the seat between any number of positions.

### CROSS-REFERENCE TO RELATED APPLICATIONS

This application claims the benefit of U.S. provisional application Ser. No. 60/950,207 filed Jul. 17, 2007.

### BACKGROUND OF THE INVENTION

1. Field of the Invention

The present invention relates to systems having motorized features for articulating a seat.

2. Background Art

Vehicle seating systems and other seating arrangements may include a seat bottom and seat back. The seat bottom and/or back may be articulated to various positions, such as to facilitate occupant comfort, seat storage, and movement into and out of a vehicle. In some case, the seats are articulated with a number of manual operations. For example, a seat occupant may articulate the seat by physically actuating a lever while at the same time applying force to another portion of the seat. This type of operation requires the occupant to be in close proximity to the seat, if not in the seat.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a seat fold actuator in accordance with one non-limiting aspect of the present invention;

FIGS. 2-3 illustrate exploded views of the seat fold actuator in accordance with one non-limiting aspect of the present invention; and

FIGS. 4-6 illustrate operation of the actuator between a design, recline, and fold-flat position in accordance with one non-limiting aspect of the present invention.

### DETAILED DESCRIPTION OF THE PREFERRED EMBODIMENT(S)

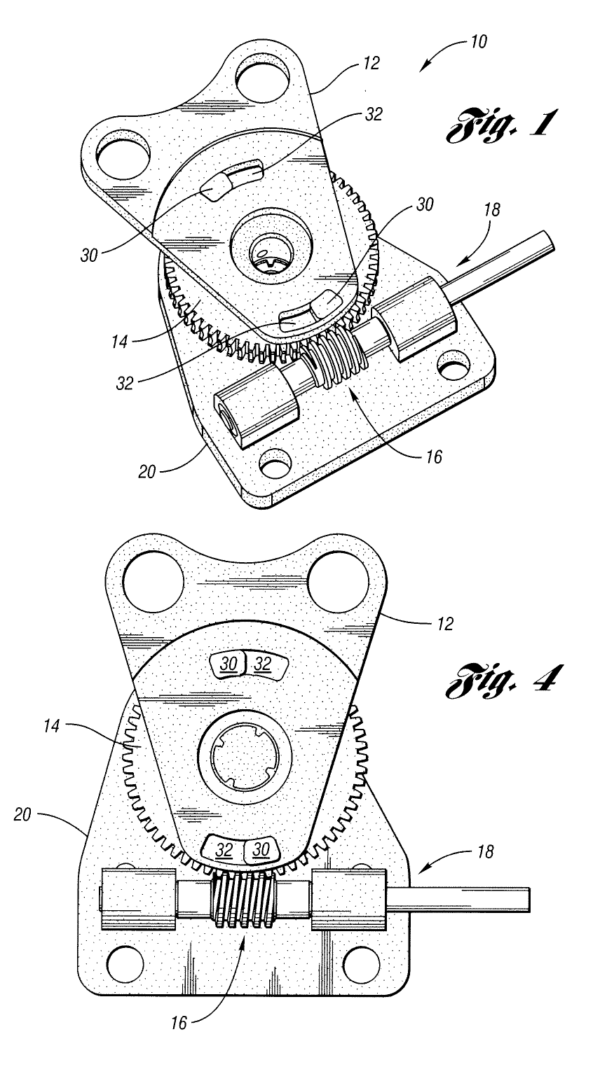

FIG. 1 illustrates a seat fold actuator 10 in accordance with one non-limiting aspect of the present invention. The seat fold actuator 10 may be configured to facilitate articulating a seat (not shown) between various positions. For exemplary purposes, the cushioning and related infrastructure for supporting the occupant and attaching the seat to the vehicle floor are not shown. The present invention contemplates the use of any attachment system and support infrastructure. A seat bottom bracket 20 and seat back bracket 12 are instead shown to illustrate one type of connection feature that may be used with the present invention to facilitate the contemplated articulation of the seat.

The present invention is predominately described with respect to articulating the seat back, or more particularly the seat back bracket 12. This is done for exemplary purposes and without intending to limit the scope and contemplation of the present invention. The present invention fully contemplates using the actuator to articulate any portion or multiple portions of the seat, including the seat bottom. The actuator 10 is also predominantly described with respect to automotive applications and environments for exemplary purposed only. The present invention is not intended to be so limited.

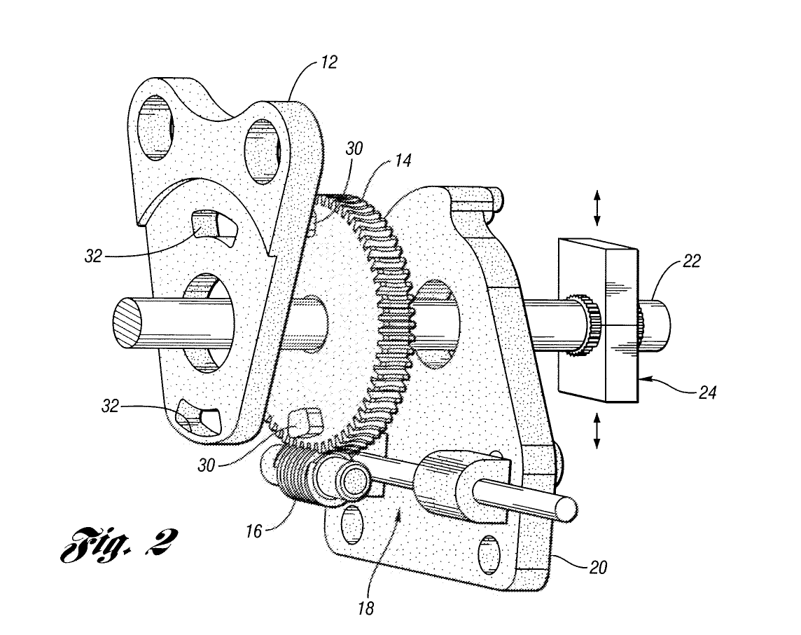

FIGS. 2-3 illustrate exploded views of the seat fold actuator 10 in accordance with one non-limiting aspect of the present invention. The seat fold actuator 10 may include any number of features and elements to facilitate the operations contemplated by the present invention, including but not limited to seat back bracket 12, worm gear 14, worm 16, worm drive 18, and seat bottom bracket 20. These features may cooperate with other seat features to facilitate positioning the seat back, such as but not limited to an axle 22 and locking mechanism 24.

The axle 22 may be used to provide a pivot point about which the seat back rotates. The locking mechanism 24 may be an independent element that is operable between locked and unlocked states. The locked state may correspond with pawls on the locking mechanism 24 engage the seat axle 22 in such a manner that the seat back is unable to articulate about the axle. This may require the locking mechanism 24 to operate and/or connect with other non-illustrated features on the seat. The unlocked state may correspond with disengagement of the pawls from the axle 22 such that the locking mechanism is free to articulate about the pivot, assuming that the actuator 10 is not otherwise preventing the articulation.

The actuator 10 may include a controller or other feature (not shown) for controlling the worm drive 18 to turn or rotate the worm 16 in a sufficient manner to facilitate inducing a corresponding rotation in the worm gear 14. The seat back bracket 12 may be operatively connected to the worm gear 14 such that the rotation of the worm gear 14 results in a corresponding rotation of the seat back. This movement may be used to facilitate positioning the seat, or more particularly, the seat back relative to the seat bottom. While a worm and worm gear arrangement is shown, any combination of mating gears may be used without deviating from the scope and contemplation of the present invention, including but not limited to bevel, pinion, and spur arrangements.

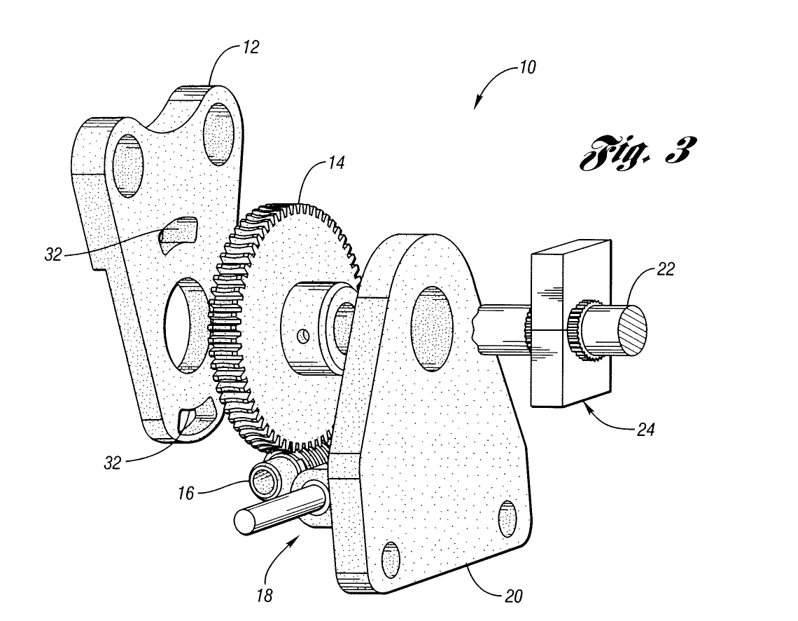

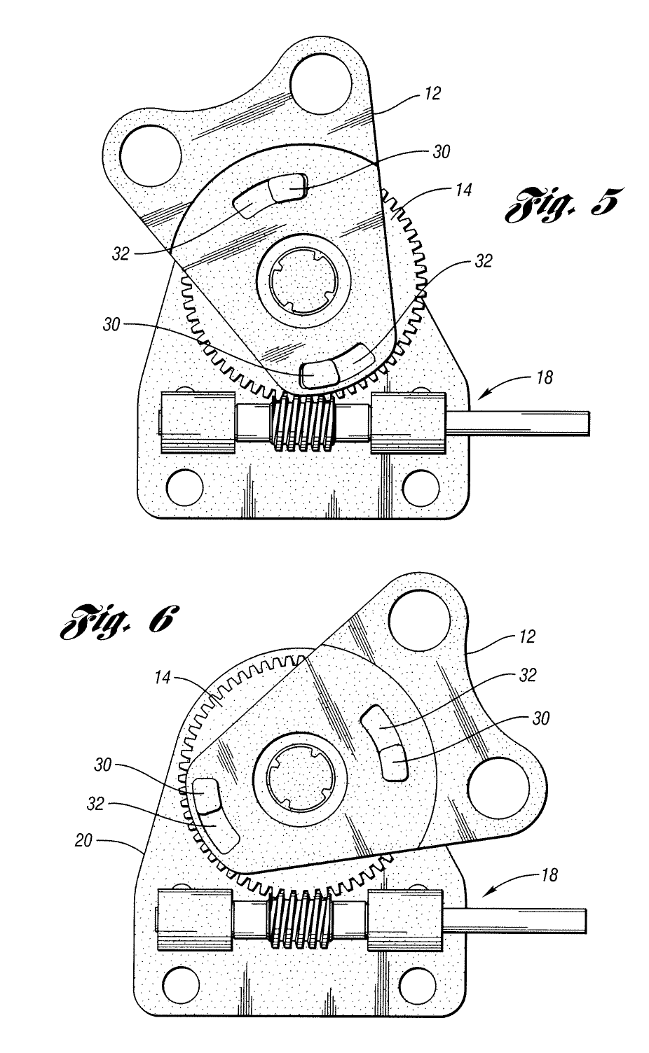

FIGS. 4-6 illustrate operation of the actuator 10 between a design, recline, and fold-flat position in accordance with one non-limiting aspect of the present invention. FIG. 4 illustrates the design position, FIG. 5 illustrates the recline position, and FIG. 6 illustrates the fold-flat position.

The design position may correspond with a desired positioning of the seat back relative to the seat bottom. The illustrated position is shown to generally correspond with the seat back being almost perpendicular to the seat bottom. This is for exemplary purposes only as the design position may correspond with any angle of the seat back and it may be adjusted or otherwise selected by the passengers. In the design position, a stopper 30 connected to the worm gear 14 may be positioned at a left end side of an arched relief or groove 32 included within the seat back bracket 12.

The reclined position may correspond with the stopper 30 being positioned at some distance rightward of the left end side of the relief 32. As shown, the stopper 30 is positioned at the right end side of the relief 32. This change in positioning results in the seat back being slightly inclined relative to the design position and in proportion to the distance the stopper 30 travels from the design position. The movement between the design and recline position may be made through a manual operation where the passenger releases a handle (not shown) used to retract the pawls of the locking mechanism 24 from the axle.

Once the pawls are retracted, the seat back bracket 12 may be positioned at any location along the relief and thereafter locked back in place with release of the handle, which re-engages the pawls. The relief 32 may be larger or smaller to facilitate providing more or less recline. The amount of travel may be limited to a different in width between the stopper 30 and the groove 32. The seat back bracket 12 is free to travel anytime the locking mechanism 24 is unlocked. Once the stopper 30 reaches the other side of the groove 32, any remaining force is applied against the worm drive 18.

Optionally the controller may place the worm drive 18 or other drive in a neutral gear that allows it to spin freely so that if the force applied to the side of the groove 32 is sufficient, the worm gear 14 may be further articulated about the axle 20. The worm drive 18 may be locked in place or placed in gear to prevent rotation of the worm gear 14, either before or after the worm gear 14 starts to rotate. This would prevent further articulation of the seat back, at least until the applied force overcomes the resistance of the worm drive 18. The ability to electronically engage and disengage the worm drive 18 can be used to electronically control an amount of recline that the occupant is able to perform. Sensors or other features (not shown) may be included to monitor to the amount of travel and be used by the controller to facilitate selectively engaging the worm drive 18.

The fold-flat position may correspond with the seat back being positioned in an opposite position to the reclined position such that it lies substantially flat against the seat bottom. The fold-flat position is shown for exemplary purposes only and to correspond with movement in an opposite direction with respect to the recline position. The fold-flat position may correspond with other movement of the seat back, including movement in the same direction as that associated with reclined position.

The fold-flat position may require the seat back to rotate about a distance greater than that provided by the relief 32. This may be achieved with the worm drive 18 rotating the worm gear 14 to the desired positioning of the seat back bracket 12. The rotation of the worm gear 14, as long as the pawls are released, allows the stoppers 30 to rotate the seat back bracket 12 relative to the seat bottom bracket 20. The worm drive 18 may be used in this manner to electronically motor the seat back between any position and to facilitate folding the seat up and down. The stoppers 32 included on the worm gear 14 may be used to stall the worm drive 18 if the drive 18 continues to operate and the locking mechanism 24 is returned to the locked state.

The operation of the worm drive portion may be coordinated with other controls. This may include a passenger pressing a button within the vehicle or on a key fob to instigate folding the seat to the fold-flat or other desired position. The electronics or other controller in the vehicle may receive the request and instigate release of the pawls through automated operation. Once this operation releases the pawls, the electronics or other controller may be used to control operation of the worm drive 18 to position the seat back into the desired positioning.

Thereafter, the user may actuate a similar button to instruct the worm drive 18 to return the seat back to the upright or design position. Optionally, manual actuation of the pawls may be instigated to allow manual return of the seat and/or manual release of the pawls may be coordinated with electronic control of the worm drive to automatically position the seat with manual release of the pawls.

As described above, the actuator 10 may be used to articulate any portion of seating system, such as but not limited to a seat back. The actuator 10 may be a motorized device in that the worm drive 18 may be turned by an electric motor to facilitate positioning the seat back. Optionally, the grooves 32 included with the seat back bracket 20 may be used to allow at least partial articulation of the seat back while the worm drive 18 is stopped. This can be helpful in allowing an occupant to partially position the seat without having to engage the worm drive motor. The use of a locking mechanism 24 can be helpful in reducing the loads on the worm drive 18 and to facilitate the non-motorized positioning. Of course, any other features and elements may be used to facilitate the motorized and non-motorized positioning contemplated by the present invention.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A seat back fold system comprising:
a seat back configured to rotate about a first axis;
a gear that also rotates about the first axis and that is operatively connected to the seat back; and
a motorized drive that rotates about a second axis that is orthogonal to the first axis, the drive being operatively connected to the gear such that sufficient rotation of the drive about the second axis causes the worm gear to rotate the seat back about the first axis.

2. The system of claim 1 wherein a connection between the gear and seat back allows the seat back to partially rotate when the gear is held in a fixed position.

3. The system of claim 2 wherein the connection between the gear and the seat back is defined by a bracket included in the seat back having a groove that receives a stopper included on a face of the gear.

4. The system of claim 3 wherein a width of the groove is greater than a width of the stopper.

5. The system of claim 4 wherein an amount that the seat back is able to partially rotate when the gear is held in the fixed position is proportional to a difference in width between the width of the stopper and the width of the groove.

6. The system of claim 3 wherein the gear is only able to rotate the bracket when the stopper presses against a side of the groove.

7. The system of claim 6 further comprising a locking mechanism operably connected to the seat back bracket that is operable between locked and unlocked positions, the locked position preventing the seat bracket from rotating and the unlocked position freeing the seat back to rotate, and wherein the drive is only able to rotate the seat back when the locking mechanism is in the unlocked position.

8. The system of claim 7 wherein the seat back bracket is unable to partially rotate when the gear is held in the fixed position unless the locking mechanism is in the unlocked position.

9. The system of claim 1 wherein the drive includes a having spirally shaped grooves that engage with teeth included on an outer diameter of the gear, wherein the teeth travel along the spirally shaped grooves when the drive rotates.

10. A motorized seat comprising:
a seat back bracket attached to a seat back;
a motorized driver operatively connected to the seat back bracket that rotates the seat back bracket about a first axis, wherein a connection between the seat back bracket and the motorized driver allows the seat back bracket to be rotated when the motorized driver is stopped.

11. The system of claim 10 wherein the motorized driver includes a gear that rotates about the first axis, wherein the gear includes an element that acts against the seat back bracket when the driver is used to rotate the seat back, wherein the element is held in a fixed position when the driver is stopped.

12. The system of claim 11 wherein the seat back bracket includes a groove that receives the element, wherein the element travels within the groove and against the seat back bracket when the driver is running.

13. The system of claim 12 wherein a width of the groove is greater than a width of the element, the difference in widths allowing the seat back bracket to rotate when the driver is stopped.

14. The system of claim 13 wherein the element must travel the width of the groove before the seat back bracket begins to rotate if the seat back bracket was rotated while the driver was stopped.

15. The system of claim 11 wherein the element is a stopper that extends sidewise from a face of the gear.

16. The system of claim 15 wherein the driver includes a rotary element that rotates about a second axis, wherein the rotary element is configured to cooperate with teeth include on a perimeter of the gear in order to cause the gear to rotate and the seat back to be correspondingly rotated about the first axis.

17. The system of claim 10 wherein the seat back includes a bracket and the motorized driver includes a gear, the gear and bracket rotate about the first axis, the gear includes at least two stoppers that engage separate grooves included on the bracket.

18. The system of claim 17 wherein the grooves are wider than the stoppers, wherein the seat back bracket is able to rotate without the gear rotating for a distance equal to a difference in width between the stoppers and the grooves.

19. The system of claim 18 further comprising a locking mechanism that is configured to lock the seat back bracket independently of the operation of the motorized driver.

20. The system of claim 19 wherein the motorized driver is unable to rotate the seat back when the locking mechanism is locked.
